(19) United States
(12) Patent Application Publication
(10) Pub. No.: US 2019/0004996 A1
(43) Pub. Date: Jan. 3, 2019

(54) Convex Relaxation Regression Systems and Related Methods

(71) Applicant: Rehabilitation Institute of Chicago, Chicago, IL (US)

(72) Inventors: Mohammad G. Azar, Chicago, IL (US); Eva Dyer, Chicago, IL (US); Konrad Kording, Chicago, IL (US)

(73) Assignee: Northwestern University, Evanston, IL (US)

(21) Appl. No.: 16/113,035

(22) Filed: Aug. 27, 2018

Related U.S. Application Data
(63) Continuation of application No. 15/400,941, filed on Jan. 6, 2017, now abandoned.
(60) Provisional application No. 62/276,679, filed on Jan. 8, 2016.

(51) Int. Cl. G06F 17/11

(52) U.S. Cl. CPC G06F 17/11

(57) ABSTRACT

A computer implemented method for optimizing a function is disclosed. The method may comprise identifying an empirical convex envelope, on the basis of a hyperparameter, that estimates the convex envelope of the function; optimizing the empirical convex envelope; and providing the result of optimizing the empirical convex envelope as an estimate of the optimization of the first function.

### RELATED APPLICATIONS

This patent claims priority to U.S. patent application Ser. No. 15/400,941, filed Jan. 6, 2017, entitled “Convex Relaxation Regression Systems and Related Methods,” and to U.S. Provisional Patent Application Ser. No. 62/276,679, filed Jan. 8, 2016, entitled “Non-Convex Function Optimizers.” The entireties of U.S. patent application Ser. No. 15/400,941 and U.S. Provisional Patent Application Ser. No. 62/276,679 are incorporated herein by reference.

### FEDERALLY SPONSORED RESEARCH OR DEVELOPMENT

This invention was made with government support under Award No. 5R01MH103910 awarded by the United States National Institutes of Health. The government has certain rights in the invention.

### MICROFICHE/COPYRIGHT REFERENCE

[Not Applicable]

### BACKGROUND

Significant problems in many technological, biomedical, and manufacturing industries can be described as problems that require the optimization of a multi-dimensional function. For instance, determining how a protein in the human body folds can be reduced to an optimization problem. The same is true for other challenges in the computer arts, such as assisting computers in identifying objects in a picture or a video file; face recognition in computer vision; smart grid solutions; imaging system optimization for neuroimaging; training of neural networks, such as neural networks for speech processing or machine translation; music and speech synthesis; natural language processing; reinforcement learning; and robotics. Often, these multi-dimensional functions have a high number of dimensions, in the hundreds or the thousands. Often, these functions are non-convex.

Modern machine learning relies heavily on optimization techniques to extract information from large and noisy datasets. Convex optimization methods are widely used in machine learning applications, due to fact that convex problems can be solved efficiently, often with a first order method such as gradient descent. A wide class of problems can be cast as convex optimization problems. However, many learning problems such as binary classification, sparse and low-rank matrix recovery and training multi-layer neural networks are non-convex optimization problems. In many cases, non-convex optimization problems can be solved by first relaxing the problem: convex relaxation techniques find a convex function that approximates the original objective function. Examples of problems for which convex relaxation are known include binary classification sparse approximation and low rank matrix recovery.

When a convex relaxation is known, then the underlying non-convex problem can often be solved by optimizing its convex surrogate in lieu of the original non-convex problem. However, there are important classes of machine learning problems for which no convex relaxation is known. For instance, there exist a large class of problems where all that can be acquired is samples from the function, especially when no gradient information is available.

These include some of the most well-studied machine learning problems such as training deep neural nets, estimating latent variable models (mixture density models), optimal control, and reinforcement learning. Thus, methods for finding convex relaxations of a non-convex function would have wide reaching impacts throughout machine learning and the computational sciences.

### BRIEF SUMMARY

In an embodiment, a computer implemented method for optimizing a first function is provided. The method may comprise identifying an empirical convex envelope, on the basis of a hyperparameter, that estimates the convex envelope of the first function; optimizing the empirical convex envelope; and providing the result of optimizing the empirical convex envelope as an estimate of the optimization of the first function.

The method may further comprise providing a plurality of predetermined values for the hyperparameter; for each predetermined value, performing the described method such that the value of the hyperparameter is equal to the predetermined value; and selecting the optimized result from the results provided by the performance of the method of claim 1 for each predetermined value.

The optimized result from the result provided by the performance of the method of for each predetermined value may be the minimum returned value or the maximum returned value.

In an embodiment, the empirical convex envelope may be a parameterized convex function. The empirical convex envelope may have an expected value over a set of input values that is equal to the value of the hyperparameter. The empirical convex envelope may minimize the expected value of the sum of absolute differences between the minimum convex envelope and the first function.

In an embodiment, the step of optimizing the empirical convex envelope may be performed using one of the following: a least squares optimizer, a linear programming optimizer, a convex quadratic minimization with linear constraints optimizer, a quadratic minimization with convex quadratic constraints optimizer, a conic optimizer, a geometric programming optimizer, a second order cone programming optimizer, a semidefinite programming optimizer, or an entropy maximization with appropriate constraints optimizer.

In various embodiments, the first function may be a non-convex function. The first function may have at least ten dimensions.

In an embodiment, the methods described herein may be implemented on a distributed computing system.

The first function being optimized may be, for example, a neural network function, a protein folding function, a facial recognition function, a speech recognition function, an object recognition function, or a natural language processing function.

### BRIEF DESCRIPTION OF THE SEVERAL VIEWS OF THE DRAWINGS

FIG. 1 displays a test function whose minimum is estimated using an underestimate model, an optimal model, a model according to embodiments of the methods described herein, and an overestimate model. FIG. 1 further corresponds those estimations to the value of the test function for various values of a hyperparameter.

FIG. 2 displays an analysis of a test function.

FIG. 3 displays a graphical representation of an exemplary method of optimizing a function ƒ.

FIG. 4A displays plots of five test functions.

FIG. 4B displays plots of approximation error against sample size T for each of the five test functions plotted in FIG. 4A.

FIG. 4C displays a three-dimensional plot for embodiments of the methods described herein being applied to the Salomon test function, and reflects the dimensions of the Salomon test function, the sample size, and the error rate.

FIG. 4D displays a plot of dimension against log of approximation error for embodiments of the methods described herein, a Quasi-Newton method, and a Simulated Annealing method.

FIG. 5 displays a graphical representation of an exemplary distributed computing system and related method.

### DETAILED DESCRIPTION

Here, we introduce methods for learning the convex relaxation of a wide class of smooth functions. Embodiments of the method are known herein as “Convex Relaxation Regression” or “CoRR”.

The general method, which is described in more detail herein, is to estimate the convex envelope of a function ƒ by evaluating ƒ at random points and then fitting a convex function to these function evaluations. The convex function that is fit is called the “empirical convex envelope.” As the number T of function evaluations grows, the solution of our method converges to the global minimum of ƒ with a polynomial rate in T. In an embodiment, the method empirically estimates the convex envelope of ƒ and then optimizes the resulting empirical convex envelope.

We have determined that the methods described here scale polynomially with the dimension of the function ƒ. The approach therefore enables the use of convex optimization tools to solve a broad class of non-convex optimization problems. For a broad class of bounded (non-convex) functions, it is possible to accurately and efficiently estimate the convex envelope from a set of function evaluations.

Embodiments described herein may be entirely hardware, entirely software, or including both hardware and software elements. In a preferred embodiment, the methods described herein are implemented in software, which includes but is not limited to firmware, resident software, microcode, etc. The software may be written in C++, Java, MATLAB, or other types of programming languages known in the art.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc. The method may be implemented on a distributed computing system comprising a plurality of computers or other instruction execution systems. A variety of different distributed computing systems exist. In one such system, each computer or other instruction execution system is connected to one or more networks that allow for communication and coordination of actions among the computers or other instruction execution systems by passing messages.

In one embodiment, a method comprises solving a constrained convex regression problem which estimates the convex envelope by a linear combination of a set of convex functions (also known as “basis vectors”). By leveraging the global structure of the data to “fill in the gaps” between samples, we can obtain an accurate estimate of the global minimum, even in high dimensions. The scaling behavior of the methods described herein makes them an attractive alternative to prior art methods that often become inefficient in large dimensions.

Proof that our methods can find accurate convex surrogates for a wide class of non-convex functions are set out at the end of this application. In sum, we prove in Thm. 1 that with a probability greater than 1−δ, we can approximate the global minimizer with error of

$$O ( {( \frac{{p}^{2} log ( 1 / δ}{T} )}^{α / 2} ) ,$$

where T is the number of function evaluations and p is the number of bases used to estimate the convex envelope. α>0 depends on the local smoothness of function around its minimum. This result assumes that the true convex envelope lies in the function class H used to form a convex approximation. In Thm. 2, we extend this result for the case where the convex envelope is in the proximity of H.

To demonstrate the utility of our methods for solving high-dimensional non-convex problems, we compare them with other approaches for gradient-based and derivative-free optimization on two multi-dimensional benchmark problems (Sec. 5). Our numerical results demonstrate that our methods can find an accurate approximation of the original minimizer as the dimension increases. This is in contrast to local and global search methods which can fail in high dimensions. Our results suggest that the methods described herein can be used to tackle a broad class of non-convex problems that cannot be solved with existing approaches.

Notation. Let n be a positive integer. For every x∈n, its ƒ₂-norm is denoted by ∥x∥, where ∥x∥²:=<x, x> and <x, y> denotes the inner product between two vectors x∈Rn and y∈Rn. We denote the set of ƒ₂-normed bounded vectors in Rⁿ by B(Rⁿ), where for every x∈B(Rⁿ) we assume that there exists some finite scalar C such that ∥x∥<C. Let X⊆B(Rn) be a convex set of bounded vectors. We denote the set of all bounded functions on X by B(X, R), such that for every ƒ∈B(X, R) and x∈X there exists some finite scalar C>0 such that |ƒ(x)|≤C. Finally, we denote the set of all convex bounded functions on X by C(X, R)⊂B(X , R). Also for every Y⊆B(Rⁿ), we denote the convex hull of Y by conv(Y), where Y is not necessarily a convex set.

Convex envelopes. The convex envelope of function ƒ: X→R is a function ƒ^{c}: X→R such that ƒ^{c}(x)≤ƒ(x), ∀x∈X. If h is a convex function defined over X, and if h(x)≤ƒ(x) for all x∈X, then h(x)≤ƒ^{c}(x). Convex envelopes are also related to the concepts of the convex hull and the epigraph of a function. For every function ƒ: X→R the epigraph epi ƒ is defined as epi ƒ={(ξ, x):ξ≥ƒ(x), x∈X}. One can then show that the convex envelope of ƒ is obtained by ƒ^{c}(x)=inf{ξ:(ξ, x)∈conv(epi ƒ)}, ∀x∈X.

The next result shows that the minimum of the convex envelope ƒ^{c} coincides with the minimum of ƒ.

Proposition 1 Let f^{c} be the convex envelope of f: X→R. Then (a) X_{f}*⊆X_{f̂c}*, (b) minₓ_{^{∈X}}f^{c}(x)=f*. This result suggests that one can find the optimizer of the function f by optimizing its convex envelope. In the sequel, we will show how one can estimate the convex envelope efficiently from a set of function evaluations. As described in further detail below, the convex envelope may be estimated efficiently from a set of function evaluations.

Global optimization of bounded function. We consider a derivative free (zero-order) global optimization setting, where we assume that we do not have access to information about the gradient of the function we want to optimize. More formally, let F⊆B(X, R) be a class of bounded functions, where the image of every ƒ∈F is bounded by R and X is a convex set. We consider the problem of finding the global minimum of the function ƒ∈F,

ƒ*:=min_{x∈}_{_{χƒ(}}x) (1)

We denote the set of minimizers of [symbol] by X_{ƒ}*⊆X.

In the derivative-free setting, the optimizer has only access to the inputs and outputs of function ƒ. In an embodiment, a computer-implemented method is provided with a set of input points \hat{X}={x1, x2, . . . , xT} in X and a sequence of outputs {ƒ(x1), ƒ(x2), . . . , ƒ(xT)}. The set of input points may be selected a priori or may be selected in another fashion. Based upon this information, the goal is to find an estimate \hat{x}*∈X, such that the error f(\hat{x}*)−ƒ* becomes as small as possible. From Prop. 1, we know that if we had access to the convex envelope of ƒ and find the minimizer of the convex envelope, then the error will be zero.

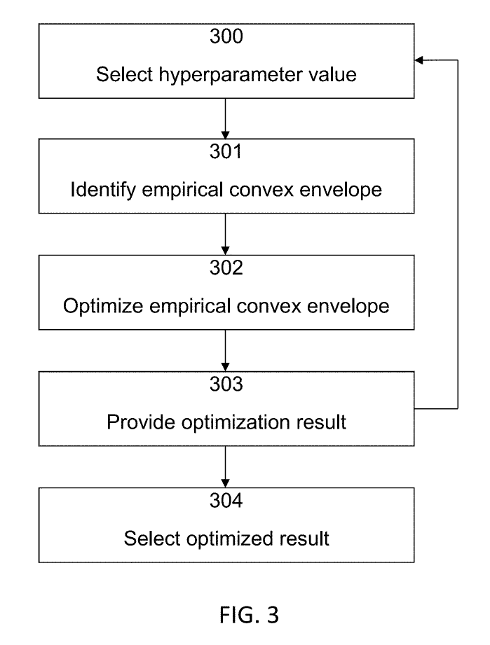

FIG. 3 displays a graphical representation of an embodiment of a computer implemented method for optimizing a function ƒ. In 300, a value is selected for a hyperparameter. In 301, an empirical convex envelope is identified, on the basis of the selected value of the hyperparameter, that estimates the convex envelope of the first function. In 302, the the empirical convex envelope is optimized. In 303, the result of the optimizing of the empirical convex envelope is provided as an estimate of the optimization of the first function. The empirical convex envelope is also referred to herein as the “estimated convex envelope” or the “convex surrogate.” The method may be performed iteratively, For example, the method may, after 303, return to 300 to select a new value is selected for the hyperparameter. Steps 301, 302, and 303 are then performed again. This process may be repeated for any desired number of different values for the hyperparameter. After the process is repeated as desired, in 304, the optimized result may be selected from the results provided all of the iterations of steps 300, 301, 302, and 303. By “optimized result” we mean the minimum of all the results provided (if the interest is finding a minimum of the function) or the maximum of all the results provided (if the interest is in finding a maximum of the function). The selected optimized result is then provided as the best estimate of the optimization of the first function.

In an embodiment, the method comprises first estimating the convex envelope ƒc and then finding an approximate solution to Eqn. 1 by optimizing this convex surrogate. The method may first involve learning a convex surrogate for ƒ from a set of function evaluations (samples). In an embodiment, the method is initialized by first drawing two sets of T samples [symbol] and X₂ from the domain X⊆B(Rⁿ) over which f is supported. To do this, the method may draw independent and identically distributed (“i.i.d.”) samples from a distribution ρ, where ρ(x)>0 for all x∈X. Note that ρ is an arbitrary distribution and thus can be simply designed to draw independent samples. For example, ρ can take the form of a normal or uniform distribution. After collecting samples from ρ, the method may construct a function class H containing a set of convex functions h(x; θ)∈H parametrized by θ∈Θ⊆B(R^{p}). Let φ: X→B(R^{p}) denote the set of p basis functions that are used to generate h(x; θ)=(θ, φ(x)). The function class may consist of convex functions that are assumed to belong to the affine class of functions in terms of θ. A function class may be selected such that for all x∈X and all h∈H, the function h(x; θ) is U-Lipschitz with respect to θ∈Θ, where U is a positive constant. That is for every x∈X, θ₁ and θ₂ in Θ the absolute difference |h(x; θ₁)−h(x; θ₂)|≤Ulθ₁−θ₂l. It may be assumed that the image of ƒ, h and φ are bounded from above and below by a constant R and the ƒ2-norm lθl≤B.

After selecting a function class H, the method may learn an approximation h(x; θ) to the convex envelope of ƒ(x) by solving the following constrained convex optimization problem.

$${min}_{θϵΘ} {\hat{𝔼}}_{1} [ \vert h ( x ; θ ) - f ( x ) \vert ] s . t . {\hat{𝔼}}_{2} [ h ( x ; θ ) ] = μ \qquad ( 2 )$$

where the empirical expectation [symbol]
ᵢ[g(x)]:=1/T_{Σx∈\hat{x}}_{ᵢ}g(x), for every g∈ [symbol] ( [symbol] ) and i∈{1,2}.

In words, our objective is to minimize the empirical loss

[symbol]

₁[|h(x; θ)−ƒ(x)|], subject to a constraint on the empirical expected value of h(x; θ). The solution of this problem provides a good approximation to the convex envelope if the coefficient μ, which we refer to as the “hyperparameter”, is set such that μ=E[ƒ^{c}(x)]. The objective function of Eq. 2 is in the form of a generalized linear model with a linear constraint. Thus it can be solved efficiently using standard optimization techniques known in the art. Some examples include a least squares optimizer, a linear programming optimizer, a convex quadratic minimization with linear constraints optimizer, a quadratic minimization with convex quadratic constraints optimizer, a conic optimizer, a geometric programming optimizer, a second order cone programming optimizer, a semidefinite programming optimizer, or an entropy maximization with appropriate constraints optimizer.

In a preferred embodiment, a good approximation to the convex envelope of ƒ may result from a sufficiently rich function class: when the true envelope ƒ^{c}∈H, then the estimate h(x; θ) approaches the convex envelope at a polynomial rate as the number of function evaluations grows (See Lem. 1). The same results in the case where ƒ^{c}∉H but rather the convex envelope is close to H (Thm. 2). After solving Eqn. 2 to find the empirical convex envelope \hat{ƒ}^{c}:=h(⋅; \hat{θ}μ), the method may minimize the function \hat{ƒ}^{c}(x) in terms of x∈X to obtain an estimate of the global minimum of f. This optimization problem can be solved efficiently through standard convex solvers due to the fact that \hat{ƒ}^{c} is convex in its support X. It should be understood that in other uses, it may be more useful to obtain a global maximum of f than a global minimum of f. “Optimizing” as used herein refers to either maximizing or minimizing a function. It should be generally understood that the specific techniques described for minimizing can be applied equally to maximizing.

In an embodiment, the method approximates the convex envelope of the function ƒ by minimizing the ƒ1-error between the fitted convex function and samples from ƒ, subject to the constraint that Ê₂[h(x; θ)]= [symbol] [ƒ^{c}(x)].

The use of Eqn. 2 for estimating the convex envelope of ƒ is justified by Lemma 1, and may be used to optimize ƒ, as it transforms a non-convex optimization problem to a linear regression problem with a linear constraint, which can be solved efficiently in very large dimensions using techniques known in the prior art. Lemma 1 is as follows:

Lemma 1. Let L(θ)= [symbol] [|h(x; θ)−ƒ(x)|] be the expected loss, where the expectation is taken with respect to the distribution ρ. Assume that there exists a set of parameters θ^{c}∈Θ such that ƒ^{c}(x)=h(x; θ^{c}) for every x∈ [symbol] . Set μ= [symbol] [ƒ^{c}(x)], where ƒ^{c}(x) is the convex envelope of ƒ(x). Then ƒ^{c}(x)=h(x; θ^{c}) is obtained by solving the following constrained organization problem.

$${θ}^{C} = {arg min}_{θϵΘ} L ( θ ) s . t . 𝔼 [ h ( x ; θ ) ] = μ \qquad ( 3 )$$

It is noted that for any function h∈H/ƒ^{c} which satisfies the constraint E[h(x; θ)]=E[ƒ^{c}(x)], the inequality L(θ)>L(θ^{c}) holds. Thus, ƒ^{c} is the only minimizer of L(θ) that satisfies the constraint E[h(x;θ)]=E[ƒ^{c}(x)]. Intuitively speaking, Lem. 1 implies that the convex envelope can be obtained by solving a least absolute error problem if the expected value of convex envelope under the distribution ρ is known. In general solving the optimization problem of Eqn. 3. However the optimization problem in Eqn. 3 can then be approximated by the empirical optimization of Eqn. 2 which can be solved efficiently using standard convex solvers. As the number of function evaluations T grows, the solution of Eqn. 2 converges to the solution of Eqn. 3 with a polynomial rate, i.e. ƒ(\hat{x})−ƒ*→0.

Algorithm 1 describes certain pseudocode that may be employed:

Algorithm 1

```
Require: Bounded set of inputs [symbol]    , a set of input points [symbol]     = {x₁, x₂, ... , x_{T}} and their
corresponding function evaluations {ƒ(x) : x ϵ [symbol]    } a class [symbol]     ⊆ [symbol]    ( [symbol]   ) of convex functions
in [symbol]     (parametrized by θ), a fixed value of μ, and a scalar R which bounds ƒ from above and
below.
    Step 1. Estimate the convex envelope.
  Estimate \hat{ƒ}^{c} = h (•; \hat{θ}_{μ}) by solving Eqn. 2 for a fixed value of μ ϵ [−R, R].
  Step 2. Optimize the empirical convex envelope.
  Find an optimizer [symbol]    _{μ}, for h(•; \hat{θ}μ)by solving [symbol]
                                    h (•;\hat{θ}_{μ}),
  return \hat{x}_{μ} and h (\hat{x}_{μ};\hat{θ}_{μ})
```

Algorithm 1 provides an accurate estimate of convex envelope if the hyperparameter μ is set to E[ƒc(x)]. However, in some instances, the method will not have access to E[ƒc(x)]. In an embodiment, the method sets the hyperparameter μ by searching for a μ which provides the optimized result. In an embodiment, the method may run multiple instances of Algorithm 1 above for different values of μ and choose the solution with the smallest ƒ(\hat{x}_{μ}). In an alternate embodiment, the method may run multiple instances of Algorithm 1 above for different values of μ and choose the solution with the largest ƒ(\hat{x}_{μ}). The search for the best μ can be done efficiently using standard search algorithms, such as hierarchical search methods, as μ is a scalar with known upper and lower bounds.

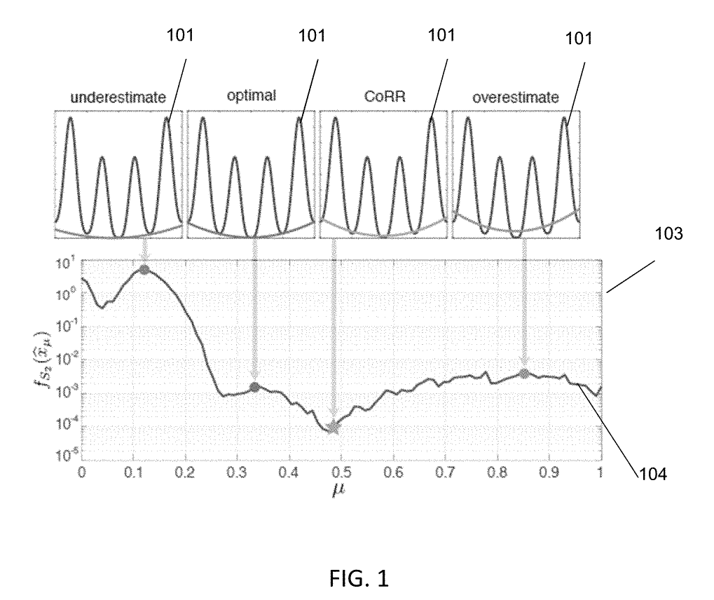

In other embodiments, optimizing the empirical convex envelope could be conducted by solving for a dual formation of the constrained convex optimization problem; solving for an unconstrained version that is obtained by adding a scaled version of the constraint on the empirical convex envelope to the mean absolute error between the function ƒ and the empirical convex envelope; or solving a constrained version that is obtained by setting the mean of the empirical convex envelope to a value equal to a fixed value of μ. Moreover, embodiments may rely on using samples of the function ƒ for solving convex constrained optimization. For example, a set of samples may be drawn from the function and evaluating the mean absolute error between the function f and the empirical convex envelope at the set of samples; a set of samples may be drawn to evaluate the mean constraint on the empirical convex envelope; a set of samples could be drawn from which to evaluate the mean constraint on the empirical convex envelope and evaluate the mean absolute error; or a set of samples could be defined according to various adaptive selection procedures.
To demonstrate the idea of how choosing the value of μ affects performance, we point the reader to FIG. 1. Along the top row of FIG. 1, we display plots 101 of the Squared Solomon function f_{S2}(x) in each of sub-sections titled “underestimate”, “optimal,” “CoRR”, and “overestimate. (The Squared Solomon function f_{S2}(x)=0.1 f_{S}(x)², where the Solomon function f_{S}(x) is defined below). Also displayed are examples of the convex surrogates obtained for different values of μ. From left to right, convex surrogates are displayed for an underestimate of μ, the empirical estimate of the convex envelope where μ=E(f_{c}(x)), the result obtained by the methods described herein, and an over-estimate of μ. In sub-section of FIG. 1 designated as 103, the value of the function f_{S2} is plotted at 104 as the value of μ varies. Here, the value of the function ƒ is shown as an embodiment of the method sweeps μ as well as examples of the convex surrogate that may be obtained for different values of μ. The output may be determined by finding the value of μ which generates the smallest function evaluation. In the example shown in FIG. 1, μ≈0.49. In contrast, the convex envelope ƒc is obtained when μ≈0.33, which may be obtained by analytically computing E[ƒ^{c}]. While our methods do not necessarily not return an estimate corresponding to the true value of μ, embodiments of the method provide a solution with even smaller error. This discrepancy is due to having a finite sample size. Thus, as the number of function evaluations grows, the minimizer obtained via our methods will approach the true value of μ.

As the number of function evaluations T grows the solution of our methods converges to the global minimum of ƒ with a polynomial rate. We also discuss the scalability of our result to high-dimensional settings.

We begin by introducing the assumptions required to state our results. The next two assumptions provide the necessary constraints on the candidate function class H and the set of all points in X that are minimizers for the function ƒ, given by X_{ƒ}*.

Assumption 1 (Convexity). We assume that the following three convexity assumptions hold with regard to every h∈ [symbol] and χ_{ƒ}*: (i) h(x) is a convex function for all x∈χ, (ii) h is an affine function of θ∈Θ for every x∈χ, and (iii) χ_{ƒ}* is a convex set. Assumption 1 does not impose convexity on the function ƒ. Rather, it requires that the set X_{ƒ}* is convex. This is needed to guarantee that both ƒ^{c} and ƒ have the same minimizers (see Prop. 2). To state our next assumption, we must first introduce the idea of a dissimilarity between two sets. Let A and B be subsets of some Y⊆B(R). We assume that the space Y equipped with a dissimilarity function l: Y²→R such that l(x, xⁱ)≥0 for all (x, xⁱ)∈Y² and l(x, x)=0. Given a dissimilarity function l, we define the distance between A and B as

$${D}_{l} ( \vert \vert ) := l ( x , {x}^{′} )$$

For g any g∈B(Y, R) with the set of minimizers Y_{g}*, we denote the distance between the set A⊆Y and Y_{g}* as D_{g,l}*( [symbol] ):=Dₗ( [symbol] ∥ [symbol] _{g}*). The distance measure D_{g,l}*(A) quantifies the maximum difference between the entries of set A with their closest points in Y_{g}*. The concept may be employed to quantify the maximum distance of the set of possible solutions of the method with respect to the optimal set X_{ƒ}*.

The following assumption quantifies the maximum width of the ε-optimal sets X_{ε} and θ_{ε}.

Assumption 2 (ε-optimality). Let ε by a positive scalar. Denote L(θ^{c}) by L*. We define the ε-optimal sets X_{ε} and Θ₂₄₉ as X_{ε}={x:x∈ [symbol] , ƒ^{c}(x)−ƒ*≤ε} and Θ₂₄₉={θ: [symbol] (h(x; θ))= [symbol] (ƒ^{c}(x)), L(θ)−L*≤ε}, respectively. We assume that there exists some finite positive scalars [symbol] ₓ, [symbol] _{θ}, βₓ, and β_{θ} such that (a) D_{ƒ}_{^{c}}_{,l}*(χ_{ε})≤ [symbol] , b, in which the dissimilarity function l′ is the [symbol] ₂-norm.

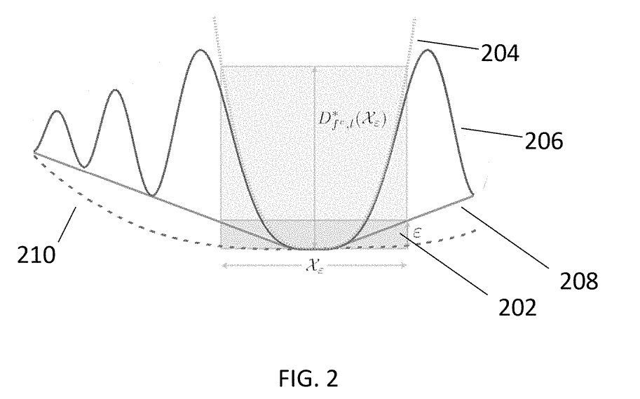

The main idea behind this assumption is displayed in FIG. 2. In this simple example, we highlight X_{ε} (item 202 in FIG. 2) the set of points x for which ƒ^{c}(x)−ƒ*≤ε. For every ε≤ƒmax, one can show that in this example D_{ƒ}_{^{c}}_{,l}*(χ_{ε})≤βₓε with respect to the dissimilarity function l(x, x*)=3|x−x*|³ (item 204 in FIG. 2), i.e., κₓ=1. In general, if the upper bound of ƒ has the same order as the lower bound of the convex envelope ƒ^{c} (item 208), then the smoothness factor κₓ=1. In this example, κₓ=1 since the function ƒ^{c} can be lower-bounded by the function 0.056|x−x*|³ (item 210). FIG. 2 displays a demonstration of E-optimality for the Langerman function (item 206 in FIG. 2). We display the dissimilarity function l(x, x*)=3|x−x*|³ (yellow dash), the convex envelope ƒ^{c} (gray solid), the set of ε-optimal points (green band), and the lower bound of convex envelope 0.056*|x−x*|³ (red dash).

Assumption 2 cannot be applied directly to the case where ƒ^{c}∉H. When ƒ^{c}∉H, we make use of the following generalized version of Assumption 2.

Assumption 3. Let \tilde{p} be a positive scalar. Assume that there exists a class of convex functions [symbol] ⊆C(χ, [symbol] ) parametrized by θ∈\tilde{Θ}⊂ [symbol] ( [symbol] ^{p}) such that (a) ƒ^{c}∈ [symbol] , (b) every h∈ [symbol] is affine w.r.t. and (c) [symbol] ⊆ [symbol] . For every positive ε define [symbol] _{ε} and \tilde{Θ}_{ε} as the set of ε-optimal points [symbol] _{ε}={x∈ [symbol] :ƒ^{c}(x)−ƒ*≤∈ and θ₂₄₉ ={θ∈\tilde{Θ}: [symbol] (h(x; θ))= [symbol] (ƒ^{c}(x)), L(θ)−L(θ^{c})≤ε}, respectively. We assume that there exists some finite positive scalars [symbol] ₓ, [symbol] _{θ},βₓ, and β_{θ} such that: (a) D_{ƒ,l}*(χ_{ε})≤ [symbol] , (b) D_{L,l}*(\tilde{Θ}_{∈})≤ [symbol] , where the dissimilarity function l′ is the [symbol] ₂-norm.

Assumption 4 establishes the necessary smoothness assumption on the function ƒ.

Assumption 4 (Local smoothness of f around its minimum). We assume that the f is locally smooth near its minimizer. That is for every x∈χ there exists some x*∈X_{ƒ}* and a dissimilarity function l such that ƒ(x)−ƒ*(x, x*). Assumption 4 is arguably one of the least stringent smoothness assumption which one can assume on ƒ, as it requires smoothness only with respect to ƒ*. Note that without assuming some form of smoothness on ƒ the optimization problem becomes impossible to solve (this is referred to as the “needle in the haystack” problem).

Finally, we introduce two assumptions on the capacity of the function class H.

Assumption 5 (Capacity of [symbol] ). We assume that ƒ^{c}∈ [symbol] . We also denote the corresponding set of parameters with ƒ^{c} by θ^{c}. That is, ƒ^{c}(x)=h(x; θ^{c})ƒ or every x∈X.
We also consider a relaxed version of Assumption 5, which assumes that fc can be approximated by [symbol] .
Assumption 6 (u−approachability of ƒ^{c} of [symbol] ). Let v be a positive scalar. Define the distance between the function class [symbol] and ƒ^{c} as d(ƒ^{c}, z,π):= [symbol] [|h(x; θ)−ƒ^{c}(x)|],
where the expectation is taken with respect to the distribution ρ.
We then assume that the following inequality holds: d(ƒ^{c}, [symbol] )≤v.

In an embodiment, the methods described herein may be applied where the convex envelop ƒ^{c}∈H. In this case, as the number of function evaluations grows, the solution of Alg. 1 converges to the optimal solution with a polynomial rate.
Theorem 1. Let Assumptions 1, 2, 4 and 5 hold. Then there exists some μ∈[−R, R] for which Alg. 1 returns \hat{x}_{μ} such that with probability (w.p.)1−δ

$$f ( {\hat{x}}_{μ} ) - {f}^{*} \leq \tilde{O} ( {{ξ}_{s} ( \frac{log ( 1 / δ )}{T} )}^{\frac{{κ}_{θ} {κ}_{x}}{2}} ) ,$$

where δ is a positive scalar, the smoothness coefficient ξ_{S}=βₓβ_{θ}^{κ}^{ₓ}U^{κ}^{ₓ}^{(1+κ}^{_{θ}}⁾(RB)^{κ}^{ₓ}^{κ}^{_{θ}}, ∥θ∥≤B, and ƒ, h and ϕ are all bounded from above and below by R.

To prove this result, we first prove bound on the error |L(\hat{θ}_{μ})−min_{θ∈Θ}L(θ)| under the constraint of Eqn. 3, for which we rely on standard results from stochastic convex optimization. This combined with the result of Lem. 1 provides bound on |L(\hat{θ}_{μ})−L(θ^{c})|. We then combine this result with Assumptions 2 and 4, which translates it to a bound on ƒ(\hat{χ}_{μ})−ƒ*. Thm. 1 guarantees that as the number of function evaluations T grows, the solution converges to ƒ* with a polynomial rate. The order of polynomial depends on the constants κₓ and κ_{θ}, which depends on the smoothness of ƒ and L.
Corollary 1. Let Assumptions 1, 2, 4, and 5 hold. Let ∈ and δ be some positive scalars. Then there exists some μ∈[−R, R] for which Alg. 1 needs

$$T = {( \frac{{ξ}_{β}}{ϵ} )}^{{κ}_{x} {κ}_{β}} log ( 1 / δ )$$

function evaluations to return \hat{χ}_{μ} such that with probability (w.p.)1−δ, ƒ(\hat{χ}_{μ})−ƒ*≤∈, where δ is a positive scalar.

The result of Thm. 1 has no explicit dependence on the dimension n. However, the Lipschitz constant U, in general, can be of O(√p), and the number of bases p typically depends on the dimension n. In fact, from function approximation theory, it is known that for a sufficiently smooth function ƒ one can achieve an e-accurate approximation of ƒ by a linear combination of O(n/ε) bases, i.e., p=O(n/ε). The dependency of our bound on n is of O(n^{κ}^{_{x(1+κβ)/2}}). This result implies that when are smaller than 1, the bound of Thm. 1 scales sub-linearly with n. When the coefficient κₓ(1+κβ)/2 is larger than 1 then the dependency on n becomes super linear. At the same time the convergence rate in this case is super-linear. So the fact that κₓ(1+κβ)/2>1 would not significantly slow down the algorithm.

Thm. 1 relies on the assumption that the convex envelope ƒ^{c} lies in the function class H. However, in general, there is no guarantee that ƒ^{c} belongs to H. When the convex envelope ƒ^{c}∉H, the result of Thm. 1 cannot be applied. However, one may expect that Alg. 1 still may find a close approximation of the global minimum as long as the distance between ƒ^{c} and H is small. To prove that the methods described find a near optimal solution in this case, one needs to show that R_{T} remains small when the distance between ƒ^{c} and H is small. We now generalize Thm. 1 to the case where the convex envelope ƒ^{c} does not lie in H but lies close to it.

Theorem 2. Let Assumptions 1, 3, 4 , and 6 hold. Then there exist some μ∈[−R, R] for which Alg. 1 returns \hat{χ}_{μ} such that ƒ or every ζ>0 with probability (w.p.)1−δ

$$f ( {\hat{χ}}_{μ} ) - {f}^{*} = \tilde{O} ( {( \sqrt{\frac{log ( 1 / δ )}{T}} + ζ + υ )}^{{κ}_{x} {κ}_{θ}} ) .$$

To demonstrate the utility of embodiments of the methods described herein for solving high-dimensional non-convex problems, we compare our methods with other approaches for gradient-based and derivative-free optimization on two multi-dimensional benchmark problems. Our numerical results demonstrate that our methods can find an accurate approximation of the original minimizer as the dimension increases. This is in contrast to local and global search methods which can fail in high dimensions. Our results suggest that our methods can be used to tackle a broad class of non-convex problems that cannot be solved with existing approaches.

We apply embodiments of our methods [symbol] two non-convex test functions. The first test function is called the Salomon function, where ƒ(x)=−cos(2π∥x∥)+0.5∥x∥+1. The second test function is called the Langerman function, ƒ(x)=−exp(∥x−α∥₂²/π)cos(π∥x−α∥₂²)+1. In the case of the Salomon function, the convex envelope can be written as ƒ^{c}(x)=0.5∥x∥. Thus, to study the performance of our methods when ƒ_{c}∈H (exact setting), a square root representation may be used, i.e. \ddot{h}(x; θ)=\sqrt{ [symbol]θ₁, x² [symbol] + [symbol] θ₂, x [symbol] +θ₃} which contains ƒ^{c}(θ=[θ₁, θ₂, θ₃]).

To study the performance of our methods when ƒ_{c}∉H (approximate setting), a quadratic basis may be used where the convex functions in H are given by h(x; θ)=<θ₁, x²>+<θ₂, x>+θ₃. When applying our methods to find a convex surrogate for the Langerman test function, the quadratic function class may be used. We compare our methods' performance with: (i) a quasi-Newton method and (ii) a hybrid approach for global optimization which combines simulated annealing (SA) [18, 19] and pattern search. We run quasi-Newton and SA for 50 random restarts and then choose the solution x* that produces the smallest function evaluation ƒ(x*). These results are then averaged over 5 trials. When computing the error for SA, we optimized the starting temperature and cooling schedule to obtain the best performance. In all of our experiments, we evaluate our methods' error for a fixed number of samples and dimension and average these results over 5 trials.

To understand how the number of samples changes the performance for different dimensions, we compute the approximation error for our methods as we vary these two parameters (FIG. 3). We display the approximation error ƒ(\hat{x}*)=ƒ* for the Salomon function when using a quadratic basis. As expected from our theory, we find a clear dependence between the dimension and number of samples. In particular, we observe that for small dimensions n=1, we obtain a high accuracy estimate of the global minimizer for all choices of sample sizes. However, as we increase the dimension to n=100, we require at least 3e⁵ samples to obtain an accurate estimate.

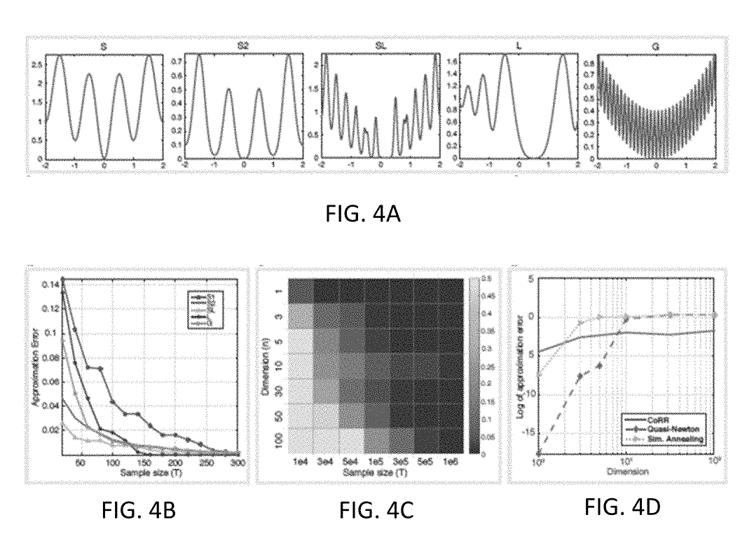

We compare the performance of our methods with a quasi-Newton and hybrid method for the Salomon and Langerman functions. The difference between the scaling behavior of our methods and other methods is particularly pronounced in the case of the Salomon function. In particular, we find that our methods are capable of finding an accurate estimate (≈7e⁻³) of the global minimizer as we increase the dimension to n=100. In contrast, both the quasi-Newton and SA methods get trapped in local minima and do not converge to the global minimizer when n>5 and n>1, respectively. We posit that this is due to the fact the minimizer of the Salomon function is at the center of the its domain [−2, 2] and as the dimension of the problem grows, drawing an initialization point that is close to the global minimizer becomes extremely difficult. In examining other test functions, we have found that other prior art methods, such as the quasi-Newton method and the hybrid simulated annealing method, all fail when the test function has more than 10 dimensions. By contrast, our methods successfully approximated the minimum or maximum of these greater-than-10 dimension test functions. By comparison, using the methods described herein, we successfully approximated the optimization of various test functions with an error smaller than 1e⁻⁵ when using one million samples. Additional test function results are shown in FIG. 4. Along the top row in FIG. 4A, five test functions are plotted: the Salomon function, the Squared Salomon function, the Salomon and Langerman combination, the Langerman function, and the Griewank function. In FIG. 4B, the mean approximation error between ƒ(\hat{x})−ƒ* as a function of the number of function evaluations T for all test functions in 1D is displayed. In FIG. 4C, the mean approximation error as a function of the dimension and number of samples for the Salomon function is displayed. In FIG. 4D, the approximation error of our methods are compared with other approaches for non-convex optimization, as the dimension is varied.

A key insight behind our methods is that they can use the global properties of the function to find a convex surrogate rather than relying on good initialization points to achieve low error. In fact, in high dimensions, we observe that most of the samples that we draw (to estimate the convex envelope and to initialize the other methods) do indeed lie near the boundary of our search space. Even in light of the fact that all of our samples are far from the global minimum, we still can obtain a good approximation to the function.

Our results suggest that the Langerman function is a much easier problem to solve than the Salomon function. In particular, we observe that QN converges to the global minimizer after multiple restarts, even for n=100. SA converges for n=5 dimensions and only converges to local minima for higher dimensions. While our methods do not converge to the true minimize in this instance, we observe that they do achieve an error on the order of 1e⁻⁴ for all of the dimensions we tested. Although we do not outperform other methods in low dimensions, our results suggest that our methods provide a powerful alternative to other approaches in high-dimensional settings.

In sum, methods herein are described that provide an efficient strategy for global optimization, both in theory and in practice. The methods will produce an estimate of a convex envelope that only exhibits weak dependence on the dimension. In numerical examples, our methods are competitive with other non-convex solvers in low-dimensions and in some cases, outperforms these methods as the dimension grows.

An embodiment of the methods finds a convex surrogate for ƒ based upon a set of samples that are drawn at random at the onset of the algorithm. We draw i.i.d. samples from a uniform distribution. However, the choice of the sampling distribution ρ has a significant impact on our estimation procedure. As such, selecting samples in an intelligent manner would improve the accuracy of the estimated convex envelope. Thus, a natural extension of our methods is to the case where we can iteratively refine our distribution ρ based upon the output of the algorithm at previous steps. For example, after performing the method set out in FIG. 3 to get an estimate of the optimized result of function ƒ, the method in FIG. 3 can be performed again using a new sampling distribution for the set of input points [symbol] ={x₁, x₂, . . . , x_{T}}. For example, the new sampling distribution can be centered around the estimate of the optimized result of function ƒ after the first iteration of the method shown in FIG. 3. Likewise, the method shown in FIG. 3 can be run a second, third, fourth, fifth, etc. time using different widths for different sampling distributions. The purpose of these different variations on the method is to find better estimates (i.e. estimates with smaller error) of the optimization of the function ƒ.

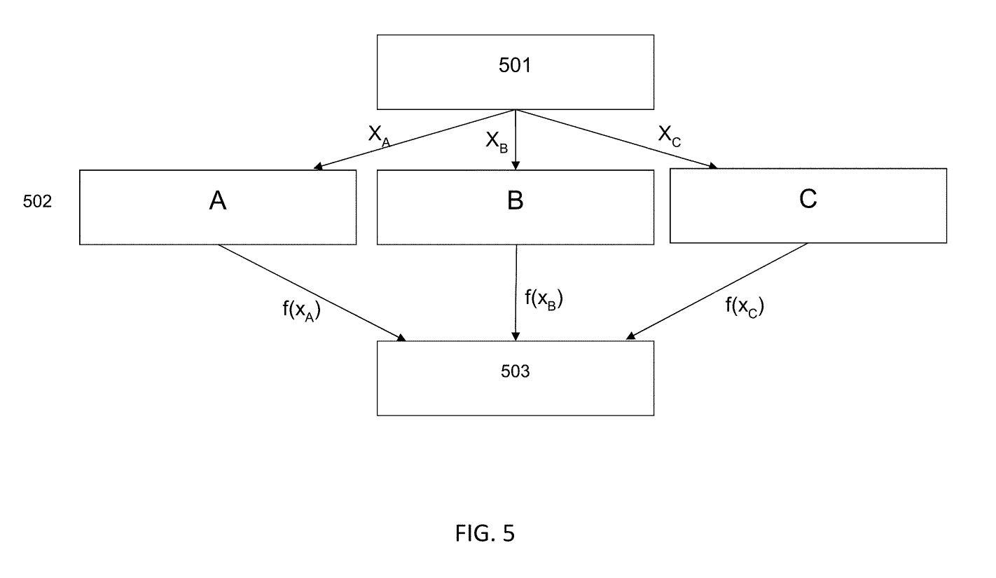

One advantage to the methods described herein is that they can be carried out in parallel in a distributed computing system. For example, some functions ƒ take a very long time to evaluate at even one input point. A computer can evaluate a function at one input point x and not return the function evaluation f(x) for an entire day. For example, optimizing a deep neural network with very large datasets can result in these kinds of processing delays. For this reason, it would be advantageous to use a distributed computing system, such that plurality of computers could be used to evaluate the set of input points [symbol] ={x₁, x₂, . . . , x_{T}}. FIG. 5 shows an exemplary method in this regard. In 501, a set of input points [symbol] ={x₁, x₂, . . . , x_{T}} is selected. A first set X_{A} are evaluated on computer A, a second set X_{B} are evaluated on computer B, and a third set X_{C} are evaluated on computer C. In 502, the function evaluations from computer A, computer B, and computer C are combined for further processing. It should be understood that the representation in FIG. 5 shows three computers for the purpose of simplicity, and tens, hundreds, thousands, tens of thousands, or more computers could be used instead. The distributed computing system could be in a single location, such as an office or a room, or could be spread across multiple locations, such as buildings, college campuses, research hospitals, homes, etc. In another embodiment, the method for identifying the empirical convex envelope could be similarly distributed among a distributed computing system. For instance, Eqn. 2 may be distributed among the plurality of computers to fit the convex envelope to the function evaluations.

Certain methods described herein show how to efficiently approximate the convex envelope of a non-convex function by solving a constrained regression problem which balances the error in fit with a constraint on the empirical expectation of the estimated convex surrogate. In other embodiments, the method may be improved by using a smart and adaptive sampling strategy.

The methods described herein may be used to solve many different kinds of problems that are important in to the continued development of technology and industry.

As stated earlier, significant problems in many technological, biomedical, and manufacturing industries can be described as problems that require the optimization of a multi-dimensional function. The methods described herein may be employed to determine how a protein folds; to assist computers to identify objects in a picture or a video file; to help computers assist in recognizing a human face; to optimize a smart grid; to optimize a neuroimaging system; to train a neural network, such as a neural network for speech processing or machine translation; to synthesize music or speech; to perform natural language processing; to perform reinforcement learning; and to optimize robotics models, such as models involving multiple joints, variables (such as torque, position, and speed), and/or degrees of freedom.

The methods described herein may also be used to optimize machine learning problems such as training deep neural nets, estimating latent variable models (mixture density models), optimal control, and reinforcement learning, problems, binary classification, sparse and low-rank matrix recovery and training multi-layer neural networks.

What is claimed is:

1. A computer implemented method for optimizing a first function, comprising:
a. identifying an empirical convex envelope, on the basis of a hyperparameter, that estimates the convex envelope of the first function;
b. optimizing the empirical convex envelope; and
c. providing the result of optimizing the empirical convex envelope as an estimate of the optimization of the first function.

2. The computer implemented method of claim 1, further comprising:
a. providing a plurality of predetermined values for the hyperparameter;
b. for each predetermined value, performing the method of claim 1 such that the value of the hyperparameter is equal to the predetermined value;
c. selecting the optimized result from the results provided by the performance of the method of claim 1 for each predetermined value.

3. The computer implemented method of claim 2, wherein the optimized result from the result provided by the performance of the method of claim 1 for each predetermined value is the minimum returned value.

4. The computer implemented method of claim 2, wherein the optimized result from the result provided by the performance of the method of claim 1 for each predetermined value is the maximum returned value.

5. The computer implemented method of claim 1, wherein the empirical convex envelope is a parameterized convex function.

6. The computer implemented method of claim 5, wherein the empirical convex envelope:
a. has an expected value over a set of input values that is equal to the value of the hyperparameter; and
b. minimizes the expected value of the sum of absolute differences between the minimum convex envelope and the first function.

7. The computer implemented method of claim 5, wherein the empirical convex envelope has an expected value over a set of input values that is equal to the value of the hyperparameter.

8. The computer implemented method of claim 5, wherein the empirical convex envelope minimizes the expected value of the sum of absolute differences between the minimum convex envelope and the first function.

9. The computer implemented method of claim 1, wherein the step of optimizing the empirical convex envelope is performed using one of the following: a least squares optimizer, a linear programming optimizer, a convex quadratic minimization with linear constraints optimizer, a quadratic minimization with convex quadratic constraints optimizer, a conic optimizer, a geometric programming optimizer, a second order cone programming optimizer, a semidefinite programming optimizer, or an entropy maximization with appropriate constraints optimizer.

10. The computer implemented method of claim 1, wherein the first function is a non-convex function.

11. The computer implemented method of claim 1, wherein the first function has at least ten dimensions.

12. The computer implemented method of claim 10, wherein the first function has at least ten dimensions.

13. The computer implemented method of claim 1, wherein the method is implemented on a distributed computing system.

14. The computer implemented method of claim 11, wherein the method is implemented on a distributed computing system.

15. The computer implemented method of claim 12, wherein the method is implemented on a distributed computing system.

16. The computer implemented method of claim 1, wherein the first function is a neural network function.

17. The computer implemented method of claim 1, wherein the first function is a protein folding function.

18. The computer implemented method of claim 1, wherein the first function is a facial recognition function.

19. The computer implemented method of claim 1, wherein the first function is a speech recognition function.

20. The computer implemented method of claim 1, wherein the first function is an object recognition function.

21. The computer implemented method of claim 1, wherein the first function is a natural language processing function.
